(19) United States
(12) Patent Application Publication
(10) Pub. No.: US 2026/0337091 A1
(43) Pub. Date: Oct. 29, 2026

(54) CRYSTALLISED GLASS

(71) Applicant: OHARA INC., SAGAMIHARA-SHI, KANAGAWA (JP)

(72) Inventors: SAYA KIKKAWA, SAGAMIHARA-SHI, KANAGAWA (JP); TOSHITAKA YAGI, SAGAMIHARA-SHI, KANAGAWA (JP)

(21) Appl. No.: 19/114,540

(22) PCT Filed: Aug. 10, 2023
(86) PCT No.: PCT/JP2023/029313

§ 371 Date: Mar. 24, 2025

(30) Foreign Application Priority Data
Sep. 22, 2022 (JP) 2022-150933

(51) Int. Cl. C03C 10/00

(52) U.S. Cl. CPC C03C 10/0027

(57) ABSTRACT

Crystallized glass including α-cristobalite and disilicate lithium as main crystal phases, wherein the crystallized glass has, by mass % in terms of oxide, a content of a SiO₂ component of 65.0% to 85.0%, a content of an Al₂O₃ component of 1.5% to 5.9%, a content of a P₂O₅ component of more than 0% and 5.0% or less, a content of a Li₂O component of 5.0% to 10.8%, and a content of a ZrO₂ component of 4.0% to 12.5%, and wherein [(the content of the SiO₂ component+the content of the Li₂O component)/the content of the Al₂O₃ component] is more than 13.9.

### FIELD OF THE DISCLOSURE

The present disclosure relates to crystallized glass, in particular hard crystallized glass.

### BACKGROUND OF THE DISCLOSURE

In recent years, in order to increase the degree of freedom in the design of smartphones, a use of a glass member has begun in a cover glass and a housing of the smartphones. These glass members are required to be less likely to be damaged, and to be less likely to crack even when subjected to an impact caused by an external factor, such as when a smartphone is dropped onto asphalt.

Crystallized glass is a type of glass having increased strength and hardness. The crystallized glass is glass in which crystals are precipitated inside, and is known to have superior mechanical strength to amorphous glass. Furthermore, it is also known that strength and hardness of glass can be increased by forming a compressive stress layer on the surface thereof with chemical strengthening or the like.

Patent Document 1 discloses a glass-ceramic material having a transparent or translucent petalite crystal phase and a lithium silicate crystal phase, which has rapid ion exchangeability and high fracture toughness.

Patent Document 2 discloses reinforced crystallized glass comprising α-cristobalite.

### RELATED ART DOCUMENTS

### Patent Documents

[Patent Document 1] JP 2021-095333 A
[Patent Document 2] JP 2022-044054 A

### SUMMARY OF THE DISCLOSURE

However, glass having higher hardness is required for applications such as glass members for a smartphone.

An object of the present disclosure is to provide hard crystallized glass.

As a result of intensive studies, the present inventors have found that crystallized glass having both of α-cristobalite and lithium disilicate as main crystal phases is obtained by heat-treating glass having a predetermined composition under a predetermined condition. The present inventors have also found that the addition of lithium disilicate to α-cristobalite increases hardness of the glass. In addition, the present inventors have found that a crystallized glass having lithium disilicate as a main crystal phase was difficult to be two-stage chemically strengthened, but it was easy to be two-stage chemically strengthened when having a predetermined composition and main crystal phases. The present inventors have completed the invention based on these findings.

The present disclosure provides the followings.

### (Configuration 1)

Crystallized glass comprising α-cristobalite and disilicate lithium as main crystal phases, wherein
the crystallized glass has, by mass % in terms of oxide,
a content of a SiO₂ component of 65.0% to 85.0%,
a content of an Al₂O₃ component of 1.5% to 5.9%,
a content of a P₂O₅ component of more than 0% and 5.0% or less,
a content of a Li₂O component of 5.0% to 10.8%, and
a content of a ZrO₂ component of 4.0% to 12.5%, and wherein
[(the content of the SiO₂ component+the content of the Li₂O component)/the content of the Al₂O₃ component] is more than 13.9.

### (Configuration 2)

The crystallized glass according to Configuration 1, wherein the crystallized glass has, by mass % in terms of oxide,
a content of a B₂O₃ component of 0% to 5.0%,
a content of a Na₂O component of 0% to 5.0%,
a content of a K₂O component of 0% to 5.0%,
a content of a MgO component of 0% to 5.0%,
a content of a CaO component of 0% to 5.0%,
a content of a ZnO component of 0% to 5.0%,
a content of a TiO₂ component of 0% to 5.0%,
a content of a Gd₂O₃ component of 0% to 5.0%,
a content of a Sb₂O₃ component of 0% to 3.0%, and
a content of a Nb₂O₅ component of 0% to 3.0%.

### (Configuration 3)

The crystallized glass according to Configuration 1 or 2, wherein the content of the ZrO₂ component is 4.7% to 12.5%.

### (Configuration 4)

The crystallized glass according to any one of Configuration 1 to Configuration 3, wherein the content of the ZrO₂ component is more than 7% and 12.5% or less.

### (Configuration 5)

The crystallized glass according to any one of Configuration 1 to Configuration 4, wherein by mass % in terms of oxide,
[(a content of a K₂O component+a content of a Al₂O₃ component)/a content of a ZrO₂ component] is less than 0.88.

### (Configuration 6)

The crystallized glass according to any one of Configuration 1 to Configuration 5, wherein by mass % in terms of oxide,
[(a content of a P₂O₅ component+a content of a K₂O component+a content of a MgO component+a content of a Al₂O₃ component)/a content of a ZrO₂ component] is less than 1.32.

### (Configuration 7)

The crystallized glass according to any one of Configuration 1 to Configuration 6, having a compressive stress layer on the surface thereof.

### (Configuration 8)

The crystallized glass according to any one of Configuration 1 to Configuration 7, which is used for a glass member of a smartphone.

According to the present disclosure, hard crystallized glass can be provided.

In view of the crystallized glass of the present disclosure having the property of high hardness, the crystallized glass of the present disclosure may be utilized as a housing of a smartphone, a member of a portable electronic device such as a tablet PC and a wearable terminal, and a protective protector used in a transport vehicle such as a car and an airplane, a member of a substrate for a head-up display, or the like.

### DETAILED DESCRIPTION OF THE EXEMPLARY EMBODIMENTS

Embodiments and examples of the crystallized glass of the present disclosure will be described in detail below. However, the present disclosure is not limited to the following embodiments and examples, and may be implemented by making modifications as appropriate within the scope of the purpose of the present disclosure.

As used herein, contents of each component are all expressed by mass % in terms of oxide unless otherwise specified. Here, “by mass % in terms of an oxide” means, if it is assumed that all the constituent components included in the crystallized glass are decomposed and converted into oxides, when a total amount of the oxides is 100 mass %, an amount of oxides in each of the components contained in the crystallized glass is expressed by mass %. As used herein, “A % to B %” represents A % or more and B % or less.

The crystallized glass of the present disclosure includes α-cristobalite and lithium disilicate as main crystal phases. By having both of these crystal phases in a predetermined composition, the hardness of the crystallized glass of the present disclosure is further increased compared to crystallized glass having α-cristobalite but not having lithium disilicate. The crystal phase also includes a solid solution.

As used herein, the term “main crystal phase” refers to the most abundant crystal phase among the major crystal phases identified from the peaks of the X-ray diffractogram of the crystallized glass, i.e., the first and second most abundant crystal phases. α-Cristobalite may be the first main crystal phase and lithium disilicate may be the first main crystal phase.

Crystallized glass may further have one or more other crystal phases selected from petalite crystal, bargilite crystal, quartz crystal, and lithium monosilicate crystal, but preferably these crystal phases are small in content or absent.

Crystallized glass having α-cristobalite and lithium disilicate as main crystal phases is obtained by heat-treatment to crystallize a raw glass having the following composition.

The composition of the crystallized glass has, by mass % in terms of oxide,
a content of a SiO₂ component of 65.0% to 85.0%,
a content of an Al₂O₃ component of 1.5% to 5.9%,
a content of a P₂O₅ component of more than 0% and 5.0% or less,
a content of a Li₂O component of 5.0% to 10.8%,
a content of a ZrO₂ component of 4.0% to 12.5%, and
[(the content of the SiO₂ component+the content of the Li₂O component)/the content of the Al₂O₃ component] is more than 13.9.

In particular, by setting the contents of the SiO₂ component, the Al₂O₃ component, and the Li₂O component to the above-described ranges, the predetermined crystal phases can be obtained. When the content of the Al₂O₃ component is larger than the upper limit, the lithium aluminum silicate crystal phase is likely to be generated, and when the contents of the SiO₂ component and the Li₂O content are outside the above ranges, only α-cristobalite is likely to be generated without forming lithium disilicate.

The SiO₂ component is a framework component constituting the crystallized glass, and is an essential component necessary to increase stability of the crystallized glass and to precipitate the desired crystal phases. When the content of the SiO₂ component is 85.0% or less, it is possible to suppress an excessive increase in viscosity and decrease in meltability, and when the content is 65.0% or more, it is possible to increase the stability of the crystallized glass.

Therefore, the upper limit thereof is preferably 85.0% or less, more preferably 83.0% or less, and still more preferably 80.0% or less. Further, the lower limit thereof is preferably 65.0% or more, more preferably 68.0% or more, and still more preferably more than 70.0%.

The Al₂O₃ component is a framework component constituting the crystallized glass, and is an essential component required to enhance stability of the crystallized glass. When the content of the Al₂O₃ component is 5.9% or less, the transmittance at 450 nm can be increased, decrease in transparency can be suppressed, and when the content is 1.5% or more, decrease in stability of the cristallized glass can be suppressed.

Therefore, the upper limit thereof is preferably 5.9% or less, more preferably 5.5% or less, and still more preferably 5.3% or less. Further, the lower limit thereof may be preferably 1.5% or more, more preferably 1.8% or more, and still more preferably 2.0% or more.

P₂O₅ component is an essential component that promotes crystal formation of the crystallized glass. When the content of the P₂O₅ component is 5.0% or less, it is possible to suppress the phase separation of the glass. Further, if the content thereof is 0%, the desired crystal phase cannot be obtained.

Therefore, the upper limit thereof is preferably 5.0% or less, more preferably 4.5% or less, and still more preferably 4.0% or less. Further, the lower limit thereof may be preferably more than 0%, more preferably 0.5% or more, and still more preferably 1.0% or more.

The Li₂O component is an essential component that is required to increase the meltability of raw glass, to enhance the manufacturability, and to precipitate the desired crystal phases. When the content of the Li₂O component is 10.8% or less, it is possible to suppress the decrease in transparency, and when the content is 5.0% or more, it is possible to suppress the increase in viscosity and the decrease in meltability, and the manufacturability can be increased. Moreover, it is possible to obtain the desired crystal phases.

Therefore, the upper limit thereof is preferably 10.8% or less, more preferably 10.5% or less, and may be, for example, 10.2% or less, 8.9% or less, or 8.5% or less. The lower limit thereof is preferably 5.0% or more, more preferably 6.2% or more, and still more preferably 7.0% or more, and may be, for example, 8.1% or more, or 9.0% or more.

The ZrO₂ component is a component that serves as a nucleating agent for crystals. When the content of the ZrO₂ components is 12.5% or less, it is possible to suppress the decrease in meltability. When the content of the ZrO₂ component is 4.0% or more, the transmittance in 450 nm is easily increased.

Therefore, the upper limit thereof is preferably 12.5% or less, and may be, for example, 12.0% or less, 11.5% or less, 11.0% or less, 10.0% or less, or 9.0% or less. The lower limit thereof is preferably 4.0% or more, more preferably 4.7% or more, more preferably 5.7% or more, and still more preferably more than 6.9%, and may be, for example, more than 7%, or 10.5% or more.

The MgO component is an optional component. In the present disclosure, an optional component may or may not be contained. It is possible to produce the glass according to the present disclosure even when its content is 0%, but the MgO component can increase the low-temperature meltability when its content exceeds 0%. When the content of the MgO component is 5.0% or less, it becomes easier to strengthen the glass during chemical strengthening.

Therefore, the upper limit thereof may be preferably 5.0% or less, more preferably 3.0% or less, and still more preferably less than 2.0%. Further, the lower limit thereof may be preferably 0% or more, more preferably 0.1% or more, and still more preferably 0.2% or more.

The ZnO component is an optional component. It is possible to produce the glass according to the present disclosure even when its content is 0%, but the ZnO component can increase the low-temperature meltability when its content exceeds 0%. When the content of the ZnO component is 5.0% or less, it becomes easier to strengthen the glass during chemical strengthening.

Therefore, the upper limit thereof may be preferably 5.0% or less, more preferably 3.0% or less, and still more preferably less than 2.0%. Further, the lower limit thereof may be preferably 0% or more, more preferably more than 0%, still more preferably 0.1% or more, and yet still more preferably 0.2% or more.

The CaO component is an optional component. It is possible to produce the glass according to the present disclosure even when its content is 0%, but the CaO component can increase the low-temperature meltability when its content exceeds 0%. When the content of the CaO component is 5.0% or less, it becomes easier to strengthen the glass during chemical strengthening.

Therefore, the upper limit thereof may be preferably 5.0% or less, more preferably 3.0% or less, and still more preferably less than 1.0%. Further, the lower limit thereof may be preferably more than 0%, more preferably 0.1% or more, more preferably 0.2% or more, and still more preferably 0.3% or more.

The K₂O component and the Na₂O component are optional components that increase the meltability of raw glass and increase the manufacturability. When the content of each of the K₂O component and the Na₂O component is 5.0% or less, the decrease in transparency can be suppressed. Further, the glass according to the present disclosure can be produced even when the contents of the K₂O component and the Na₂O component are 0%, but when the content is more than 0%, the increase in viscosity and the decrease in meltability can be suppressed to increase productivity.

Therefore, the upper limit of the content of the Na₂O component is preferably 5.0% or less, more preferably 4.0% or less, more preferably less than 3.0%, and still more preferably less than 2.0%. The lower limit thereof is preferably 0% or more, more preferably 0.2% or more, and still more preferably 0.3% or more.

The upper limit of the content of the K₂O component is preferably 5.0% or less, more preferably 4.0% or less, and may be, for example, 3.0% or less, 2.0% or less, or 1.0% or less. The lower limit thereof is preferably 0% or more, more preferably 0.2% or more, and still more preferably 0.3% or more, and may be, for example, 0.5% or more, 1.0% or more, 2.0% or more, 2.5% or more, or 3.0% or more.

The Sb₂O₃ component is an optional component that functions as a clarifying agent in the production of raw glass. When the excessive Sb₂O₃ component is contained, the transmittance at the short-wavelength region in the visible-light region may decrease. Therefore, the upper limit thereof may be preferably 3.0% or less, more preferably 2.0% or less, more preferably 1.0% or less, more preferably 0.6% or less, still more preferably 0.5% or less. The lower limit thereof may be preferably 0% or more, more preferably 0.01% or more, and more preferably 0.03 or more.

The B₂O₃ component is an optional component that has an effect of reducing the viscosity of raw glass. When the content of the B₂O₃ component is 5.0% or less, the decrease in transparency can be suppressed. In addition, even when the content of the B₂O₃ component is 0%, the glass according to the present disclosure can be produced, but when the content is more than 0%, the increase in viscosity and the decrease in meltability of raw glass can be suppressed.

Therefore, the upper limit thereof may be preferably 5.0% or less, more preferably 4.5% or less, and still more preferably 4.0% or less. Further, the lower limit thereof may be preferably 0% or more, more preferably more than 0%, more preferably 0.1% or more, and still more preferably 0.3% or more.

The TiO₂ component is an optional component that has an effect of increasing the refractive index. When the content of the TiO₂ component is 5.0% or less, the decrease in transparency can be suppressed. Further, the glass according to the present disclosure can be produced even when the content of the TiO₂ component is 0%, but the refractive index of the glass can be increased when the content is more than 0%.

Therefore, the upper limit thereof may be preferably 5.0% or less, more preferably 4.5% or less, and more preferably 4.0% or less. Further, the lower limit thereof may be preferably 0% or more, more preferably more than 0%, more preferably 0.1% or more, and still more preferably 0.3% or more.

The Gd₂O₃ component is an optional component that has an effect of increasing the refractive index. When the content of the Gd₂O₃ component is 5.0% or less, the decrease in transparency can be suppressed. Further, the glass according to the present disclosure can be produced even when the content of the Gd₂O₃ component is 0%, but the refractive index of the glass can be increased when the content is more than 0%.

Therefore, the upper limit thereof may be preferably 5.0% or less, more preferably 4.5% or less, and more preferably 4.0% or less. Further, the lower limit thereof may be preferably 0% or more, more preferably more than 0%, more preferably 0.1% or more, and still more preferably 0.3% or more.

The Nb₂O₅ component is an optional component that has an effect of increasing the refractive index. When the content of the Nb₂O₅ component is 3.0% or less, the decrease in transparency can be suppressed. Further, the glass according to the present disclosure can be produced even when the content of the Nb₂O₅ component is 0%, but the refractive index of the glass can be increased when the content is more than 0%.

Therefore, the upper limit thereof may be preferably 3.0% or less, more preferably 2.0% or less, and more preferably 1.0% or less. Further, the lower limit thereof may be preferably 0% or more, more preferably more than 0%, more preferably 0.1% or more, and still more preferably 0.3% or more.

The SrO component and the BaO component are optional components. The glass according to the present disclosure can be produced even when their contents are 0%, but the SrO component and the BaO component increase the low-temperature meltability when the content is more than 0%. When the content of each of the SrO component and the BaO component is 5.0% or less, it becomes easier to strengthen the glass during chemical strengthening.

Therefore, the upper limit of the content of each of the SrO component and the BaO component may be preferably 5.0% or less, more preferably 3.0% or less, and still more preferably 1.0% or less.

When the total content of the CaO component and the MgO component [the content of the CaO component+the content of the MgO component] is 5.0% or less, it is possible to suppress difficulty in performing chemical strengthening, and even when the total content is 0%, it is possible to produce the glass according to the present disclosure, but the decrease in meltability can be suppressed when the total content is more than 0%.

Therefore, the upper limit of [the content of the CaO component+the content of the MgO component] is preferably 5.0% or less, more preferably 3.0% or less, still more preferably less than 3.0%, and yet still more preferably 1.0% or less.

In addition, the lower limit of [the content of CaO component+the content of MgO component] may be preferably 0% or more, more preferably 0.1% or more, and still more preferably 0.2% or more.

Even when the total content of the K₂O component and the Na₂O component [the content of the K₂O component+the content of the Na₂O component] is 0%, it is possible to produce the glass according to the present disclosure, but the increase in viscosity can be suppressed and increase of the melting temperature can be suppressed when the total content is more than 0%. Further, when the total content is 5.0% or less, it is possible to suppress decrease in transparency.

Therefore, the upper limit of [the content of the K₂O component+the content of the Na₂O component] is preferably 5.0% or less, more preferably 4.0% or less, more preferably less than 4.0%, more preferably less than 3.0%, and still more preferably less than 2.0%. The lower limit thereof is preferably 0% or more, more preferably 0.2% or more, and still more preferably 0.3% or more.

When [(the content of the SiO₂ component+the content of the Li₂O component)/the content of the Al₂O₃ component] is more than 13.9, α-cristobalite and lithium disilicate can be produced as the main crystal phases.

Therefore, the upper limit of [(the content of the SiO₂ component+the content of the Li₂O component)/the content of the Al₂O₃ component] is preferably 50.0 or less, more preferably 48.0 or less, and still more preferably 45.0 or less. The lower limit thereof is preferably more than 13.9, more preferably 14.5 or more, and still more preferably 15.0 or more.

[(The content of the K₂O component+the content of the Al₂O₃ component)/the content of the ZrO₂ component] may be less than 0.88. When [(the content of the K₂O component+the content of the Al₂O₃ component)/the content of the ZrO₂ component] is less than 0.88, α-cristobalite and lithium disilicate can be easily formed as the main crystal phases.

Therefore, the upper limit of [(the content of the K₂O component+the content of the Al₂O₃ component)/the content of the ZrO₂ component] is preferably less than 0.88, more preferably 0.87 or less, and still more preferably 0.85 or less. The lower limit thereof is preferably 0.10 or more, more preferably 0.15 or more, and still more preferably 0.20 or more.

[(The content of the P₂O₅ component+the content of the K₂O component+the content of the MgO component+the content of the Al₂O₃ component)/the content of the ZrO₂ component] may be less than 1.32. When [(the content of the P₂O₅ component+the content of the K₂O component+the content of the MgO component+the content of the Al₂O₃ component)/the content of the ZrO₂ component] is less than 1.32, α-cristobalite and lithium disilicate can be easily formed as the main crystal phases.

Therefore, the upper limit of [(the content of the P₂O₅ component+the content of the K₂O component+the content of the MgO component+the content of the Al₂O₃ component)/the content of the ZrO₂ component] is preferably less than 1.32, more preferably 1.28 or less, and still more preferably 1.25 or less. The lower limit thereof is preferably 0.2 or more, more preferably 0.3 or more, and still more preferably 0.4 or more.

[The content of the Al₂O₃ component/the content of the ZrO₂ component] may be more than 0 and 1.0 or less. When [the content of the Al₂O₃ component/the content of the ZrO₂ component] is 1.0 or less, the desired crystal phases are easily obtained, and when [the content of the Al₂O₃ component/the content of the ZrO₂ component] is more than 0, the decrease in transparency is easily suppressed.

Therefore, the upper limit of [the content of the Al₂O₃ component/the content of the ZrO₂ component] is preferably 1.0 or less, more preferably 0.9 or less, and still more preferably 0.8 or less. The lower limit thereof is preferably more than 0, more preferably 0.1 or more, and still more preferably 0.2 or more.

[The content of the Li₂O component+the content of the Al₂O₃ component] may be 6.5% to 15.5%. When [the content of the Li₂O component+the content of the Al₂O₃ component] is 15.5% or less, the formation of the lithium aluminum silicate crystal phase is easily suppressed, and when [the content of the Li₂O component+the content of the Al₂O₃ component] is 6.5% or more, the desired crystal phases are easily obtained to stabilize the glass.

Therefore, the upper limit of [the content of the Li₂O component+the content of the Al₂O₃ component] is preferably 15.5% or less, more preferably 15.0% or less, and more preferably 14.0% or less. The lower limit thereof is preferably 6.5% or more, more preferably 8.0% or more, and still more preferably 10.0% or more.

[(The content of the Li₂O component+the content of the Al₂O₃ component)/the content of the ZrO₂ component] may be 1.0 to 2.7. When [(the content of the Li₂O component+the content of the Al₂O₃ component)/the content of the ZrO₂ component] is 2.7 or less, the formation of lithium aluminum silicate crystal phase is easily suppressed, and when [(the content of the Li₂O component+the content of the Al₂O₃ component)/the content of the ZrO₂ component] is 1.0 or more, the desired crystal phases are easily obtained to stabilize the glass.

Therefore, the upper limit of [(the content of the Li₂O component+the content of the Al₂O₃ component)/the content of the ZrO₂ component] is preferably 2.7 or less, more preferably 2.4 or less, and still more preferably 2.1 or less. The lower limit thereof is preferably 1.0 or more, more preferably 1.3 or more, and still more preferably 1.6 or more.

[The content of the SiO₂ component/(the content of the P₂O₅ component+the content of the Li₂O component+the content of the Na₂O component+the content of the K₂O component)] may be 4.5 or more. When [the content of the SiO₂ component/(the content of the P₂O₅ component+the content of the Li₂O component+the content of the Na₂O component+the content of the K₂O component)] is 4.5 or more, the desired crystal phases are easily obtained.

Therefore, the lower limit thereof is preferably 4.5 or more, and more preferably 5.0 or more. In addition, when [the content of the SiO₂ component/(the content of the P₂O₅ component+the content of the Li₂O component+the content of the Na₂O component+the content of the K₂O component)] is 20.0 or less, desired crystal phase can be precipitated to suppress excessive increase in viscosity and the decrease in meltability. Therefore, the upper limit of [the content of the SiO₂ component/(the content of the P₂O₅ component+the content of the Li₂O component+the content of the Na₂O component+the content of the K₂O component)] may be, for example, 20.0 or less, 10.0 or less, or 7.5 or less.

[The content of the K₂O component/the content of the ZrO₂ component] may be more than 0 and less than 0.5. When [the content of the K₂O component/the content of the ZrO₂ component] is less than 0.5, the desired crystal phases are easily obtained, and when [the content of the K₂O component/the content of the ZrO₂ component] is more than 0, the increase in viscosity and the decrease in meltability are suppressed, so that the manufacturability of the glass is easily enhanced.

Therefore, the upper limit of [the content of the K₂O component/the content of the ZrO₂ component] is preferably less than 0.5, more preferably 0.4 or less, and still more preferably 0.3 or less. The lower limit thereof is preferably more than 0, and more preferably 0.1 or more.

[(The content of the K₂O component+the content of the Al₂O₃ component)/the content of the ZrO₂ component] may be more than 0 and 0.85 or less. When [(the content of the K₂O component+the content of the Al₂O₃ component)/the content of the ZrO₂ component] is 0.85 or less, the formation of the lithium aluminum silicate crystal phase is easily suppressed, and when [(the content of the K₂O component+the content of the Al₂O₃ component)/the content of the ZrO₂ component] is more than 0, it becomes easily to make the glass stabilized.

Therefore, the upper limit of [(the content of the K₂O component+the content of the Al₂O₃ component)/the content of the ZrO₂ component] is preferably 0.85 or less, more preferably 0.80 or less, and still more preferably 0.75 or less. The lower limit thereof is preferably more than 0, more preferably 0.1 or more, and still more preferably 0.2 or more.

[(The content of the K₂O component+the content of the Al₂O₃ component)/(the content of the ZnO component+the content of the ZrO₂ component)] may be more than 0 and 0.95 or less. When [(the content of the K₂O component+the content of the Al₂O₃ component)/(the content of the ZnO component+the content of the ZrO₂ component)] is 0.95 or less, the formation of the lithium aluminum silicate crystal phase is easily suppressed, and when [(the content of the K₂O component+the content of the Al₂O₃ component)/(the content of the ZnO component+the content of the ZrO₂ component)] is more than 0, it becomes easily to make the glass stabilized.

Therefore, the upper limit of [(the content of the K₂O component+the content of the Al₂O₃ component)/(the content of the ZnO component+the content of the ZrO₂ component)] is preferably 0.95 or less, more preferably 0.90 or less, and still more preferably 0.85 or less. The lower limit thereof is preferably more than 0, more preferably 0.1 or more, and still more preferably 0.2 or more.

The crystallized glass of the present disclosure may or may not contain any of Bi₂O₃, Cr₂O₃, CuO, La₂O₃, MnO, MoO₃, PbO, V₂O₅, WO₃, Y₂O₃ components, respectively, as long as the effects of the present disclosure are not impaired. When the crystallized glass does not contain these components, the decrease in transmittance caused by these components is prevented.

Furthermore, the crystallized glass may or may not contain other components than those mentioned above as long as the properties of the crystallized glass according to the present disclosure are not impaired. For example, the crystallized glass may contain metal components (including oxides thereof) such as Yb, Lu, Fe, Co, Ni, and Ag.

As the glass clarifying agent, in addition to the Sb₂O₃ component, the crystallized glass may or may not contain one or two or more kinds selected from the group consisting of a SnO₂ component, a CeO₂ component, a As₂O₃ component, F, NOx, and SOx. However, the upper limit of the content of the clarifying agent may be preferably 3.0% or less, more preferably 2.0% or less, still more preferably 1.0% or less, and most preferably 0.6% or less.

On the other hand, there is a tendency to refrain from using Pb, Th, Tl, Os, Be, Cl, and Se components, which are considered in recent years as harmful chemical substances, and thus, it is preferable that these components are substantially not contained in the crystallized glass.

The Vicker's hardness (Hv0.2: Hv in the test load of 200 gf) of the crystallized glass of the present disclosure is preferably 630 or more, more preferably 690 or more, and still more preferably 710 or more. The Vicker's hardness tends to be increased by reducing the content of the ZrO₂ component, increasing the content of the Li₂O component, or reducing the content of the K₂O component.

Transmittance in the wavelength of 450 nm of the crystallized glass of the present disclosure having a thickness of 1 mm is 0% to 80%, and may be, for example, 20% or more, 30% or more, or 50% or more. Further, the transmittance may be less than 20%. The transmittance can be adjusted by the contents of the ZrO₂ component, the Li₂O component, the K₂O component, and the like.

The crystallized glass of the present disclosure can be produced by the method below. Specifically, the respective components are uniformly mixed within the predetermined content to prepare a raw mixture, and the raw mixture is melt-molded to produce raw glass. Next, the raw glass is crystallized to obtain a crystallized glass.

Heat treatment for crystal precipitation may be performed at one- or two-temperature stages.

In the two-stage heat treatment, the raw glass was firstly heat-treated at a first temperature to carried out a nucleation step, and subsequent to the nucleation step, heat-treated at a second temperature higher than that used in the nucleation step to carried out a crystal growth step.

The first temperature of the two-stage heat treatment may be preferably 400 °C to 680 °C, more preferably 450 °C to 650 °C, and still more preferably 500 °C to 600 °C. A retention time at the first temperature is preferably 30 minutes to 2000 minutes, and more preferably 180 minutes to 1440 minutes.

The second temperature in the two-stage heat treatment is preferably 680 °C or higher, for example, 700 °C to 800 °C, and more preferably 700 °C to 750 °C. The retention time at the second temperature is preferably 30 minutes to 600 minutes, and more preferably 60 minutes to 400 minutes.

In the one-stage heat treatment, the nucleation step and the crystal growth step are continuously performed at a one-stage temperature. Typically, the temperature is raised to a predetermined heat treatment temperature, is maintained for a certain period of time after reaching the predetermined heat treatment temperature, and is then lowered.

In the case of the one-stage heat treatment, the heat treatment temperature is preferably 680 °C or higher, for example, 700 °C to 800 °C and preferably 700 °C to 750 °C. Further, the retention time at the heat treatment temperature is preferably 30 minutes to 500 minutes, and more preferably 60 minutes to 400 minutes.

The crystallized glass may be strengthened to form a compressive stressed layer on the surface. In reinforced crystallized glasses, methods for forming the compressive stress layer includes a chemical strengthening method in which an alkaline component present in the surface layer of a crystallized glass is subject to an exchange reaction with an alkaline component having a larger ionic radius to form a compressive stress layer on the surface.

The chemical strengthening method may be implemented by the following steps, for example. A crystallized glass is contacted to or immersed in a molten salt of a salt containing potassium or sodium such as potassium nitrate (KNO₃), or sodium nitrate (NaNO₃), a mixed salt thereof, or a complex salt thereof. The treatment of contacting or immersing the crystallized glass to or in the molten salt (chemical strengthening treatment) may be performed in one stage or in two stages.

In the case of a one-stage chemical strengthening treatment, for example, the crystallized glass is contacted to or immersed in, for 1 minute to 1440 minutes, a salt containing potassium or sodium or a mixed salt thereof heated at 350 °C to 550 °C.

In the case of the two-stage chemical strengthening treatment, for example, the crystallized glass is first contacted to or immersed in, for 1 minute to 1440 minutes, preferably 30 minutes to 1000 minutes, a sodium salt or a mixed salt of a potassium salt and a sodium salt heated at 350 °C to 550 °C. Subsequently, secondly, the resultant crystallized glass is contacted to or immersed in, for 1 minute to 1440 minutes, preferably 60 minutes to 600 minutes, a potassium salt or a mixed salt of a potassium salt and a sodium salt heated at 350 °C to 550 °C.

Although the crystallized glass of the present disclosure contains lithium disilicate as the main crystal phase, it can be strengthened by two-stage chemical strengthening in which lithium is exchanged with sodium, and then sodium is exchanged with potassium. By applying such two-stage chemical strengthening, the compressive stress value of the outermost surface can be increased.

The compressive stress value (CS) of the outermost surface of the strengthened crystallized glass is preferably 400 MPa or more, and more preferably 500 MPa or larger. The depth when the compressive stress of the compressive stress layer is 0 MPa (DOLzero) may be preferably 120 μm or more, and more preferably 130 μm or more. The central tensile stresses (CT) may be, for example, 30 MPa or more, or 40 MPa or more.

### Examples 1 to 27 and Comparative Examples 1 and 2

### 1. Production of Crystallized Glass

Raw materials of respective components constituting a crystallized glass were selected from the corresponding oxides, hydroxides, carbonates, nitrates, fluorides, chlorides, and metaphosphate compounds. The selected raw materials were respectively weighed and mixed uniformly to obtain each composition described in Tables 1 to 4. Comparative Example 1 is Example 9 of Patent Document 2.

(Si+Li)/Al in the table is an abbreviation of [(the content of the SiO₂ component+the content of Li₂O component)/the content of the Al₂O₃ component], (K+Al)/Zr is an abbreviation of [(the content of K₂O component+the content of the Al₂O₃ component)/the content of the ZrO₂ component], (P+K+Mg+Al)/Zr is an abbreviation of [(the content of the P₂O₅ component+the content of the K₂O component+the content of the MgO component+the content of the Al₂O₃ component)/the content of the ZrO₂ component].

Next, the mixed raw materials were placed in a platinum crucible and melted in an electric furnace under conditions of at a temperature range of 1300 °C to 1600 °C for a time range of 2 to 24 hours, depending upon the difficulty of melting the glass composition. Subsequently, the molten glass was homogenized with stirring, cast into a mold after cooling the molten glass to a temperature of 1000 °C to 1450 °C, followed by slowly cooling to produce a raw glass. The obtained raw glass was heated under conditions of crystallization described in Tables 1 to 4 to prepare crystallized glass.

Crystal phases of the crystallized glass were identified based on each angle of peaks appearing in an X-ray diffraction pattern obtained by using an X-ray diffraction analyzer (D8 Discover manufactured by Bruker). The precipitated crystal phases are listed in Tables 1 to 4. In the tables, cri. is an abbreviation of α-cristobalite, LS2 is an abbreviation of lithium disilicate, LS is an abbreviation of lithium monosilicate crystals, Quartz is an abbreviation of quartz, and Petalite is an abbreviation of petalite (feldspar). In all examples, the main crystal phases were α-cristobalite and lithium disilicate.

### 2. Evaluation of Crystallized Glass

The produced crystallized glass was cut and ground to prepare a sample, and evaluated using the sample as follows. The results are shown in Tables 1 to 4.

### (1) Transmittance (λ5, λ80)

The light transmittance including reflection loss at a thickness of 1 mm was measured by using a spectrophotometer (U-4000 model manufactured by Hitachi High Technology). A wavelength (λ5) at which the transmittance is 5% and a wavelength (λ80) at which the transmittance is 80% were determined.

### (2) Transmittance

The light transmittance including reflection loss at a thickness of 1 mm was measured by using a spectrophotometer (U-4000 model manufactured by Hitachi High Technology).

### (3) Vicker's Hardness (Hv0.2)

The Vicker's hardness was indicated as a value obtained by dividing the load when a pyramid-shaped depression was formed using a square pyramid diamond indenter having an angle of 136° between opposing sides, on the sample surface, by the surface area (mm²) calculated from the length of the depression. The measurement was performed with a test load of 200 gf and a retention time of 10 seconds using a micro Vickers hardness tester HMV-G 21 D manufactured by Shimadzu Corporation.

### 3. Chemical Strengthening

As Comparative Example 2, crystallized glass having the following composition (mass %) was used. This crystallized glass contains petalite and lithium disilicate as the main crystal phases.

78.3% of SiO₂ component, 8.1% of Al₂O₃ component, 0.2% of B₂O₃ component, 11.9% of Li₂O component, 1.7% of Na₂O component, 0.0% of K₂O component, 0.0% of ZnO component, 4.0% of ZrO₂ component, and 2.2% of P₂O₅ component

In Examples 8, 24, and 27 and Comparative Example 2, the produced crystallized glass was cut and ground to obtain a crystallized glass substrate having a thickness (substrate thickness) shown in Table 5. Using this crystallized glass substrate as a base material, the first strengthening (first stage) and the second strengthening (second stage) were performed under conditions shown in Table 5 to obtain a strengthened crystallized glass.

For strengthened crystallized glass, the compressive stress value (CS [MPa]) of the outermost surface was measured using glass surface stress meter FSM-6000LE Series manufactured by Orihara Manufacturing Co., LTD. A light source having a wavelength of 596 nm was used as the light source of the measuring instrument. As the photoelastic constant at the wavelength of 596 nm, 28.2 was used as a representative value in Examples, and 26.2 was used as that in Comparative Examples. The results are shown in Table 5.

The depth when the compressive stress value of the compressive stress layer was 0 MPa (DOLzero [μm]) and central tensile stress (CT [(MPa)] were measured using a scattered photoelastic stress meter (SLP-1000, manufactured by Orihara Manufacturing Co., LTD.). A light source having a wavelength of 518 nm was used as the light source for measurement. The photoelastic constant at the wavelength of 518 nm was 28.8 as a representative value in Examples and 26.6 in Comparative Examples. The results are shown in Table 5.

TABLE 1

| | | Example 1 | Example 2 | Example 3 | Example 4 | Example 5 | Example 6 | Example 7 |
|---|---|---|---|---|---|---|---|---|
| wt. % | SiO2 | 76.86 | 76.86 | 76.86 | 69.86 | 77.86 | 71.86 | 73.37 |
| | Al2O3 | 2.74 | 2.74 | 2.74 | 2.74 | 2.74 | 3.51 | 1.82 |
| | B2O3 | | | | 1.00 | | | |
| | P2O5 | 2.04 | 2.54 | 2.04 | 2.54 | 2.04 | 2.11 | 2.13 |
| | Li2O | 10.45 | 9.95 | 9.95 | 9.95 | 9.95 | 8.12 | 8.18 |
| | Na2O | | 0.50 | | 0.50 | 0.50 | | |
| | K2O | 0.73 | 0.73 | 0.73 | 0.73 | 0.73 | 3.15 | 3.17 |
| | MgO | | | | | | 1.05 | 1.06 |
| | CaO | | | | | | 0.42 | 0.43 |
| | ZnO | 1.50 | 1.00 | 0.50 | 0.50 | 0.50 | 0.82 | 0.83 |
| | TiO2 | | | | | | | |
| | ZrO2 | 5.60 | 5.60 | 7.10 | 12.10 | 5.60 | 8.86 | 8.92 |
| | Nb2O5 | | | | | | | |
| | Gd2O3 | | | | | | | |
| | Sb2O3 | 0.08 | 0.08 | 0.08 | 0.08 | 0.08 | 0.09 | 0.09 |
| | total | 100.00 | 100.00 | 100.00 | 100.00 | 100.00 | 100.00 | 100.00 |
| | (Si + Li)/Al | 31.86 | 31.68 | 31.68 | 29.13 | 32.05 | 22.80 | 44.76 |
| | (K + Al)/Zr | 0.62 | 0.62 | 0.49 | 0.29 | 0.62 | 0.75 | 0.56 |
| | (P + K + Mg + Al)/Zr | 0.98 | 1.07 | 0.78 | 0.50 | 0.98 | 1.11 | 0.92 |
| Crystallization | Nucleation | 540 °C × | 540 °C × | 540 °C × | 540 °C × | 540 °C × | 540 °C × | 540 °C × |
| condition | temperature | 5 h | 5 h | 5 h | 5 h | 5 h | 5 h | 5 h |
| | Crystallization | 730 °C × | 730 °C × | 730 °C × | 720 °C × | 730 °C × | 720 °C × | 730 °C × |
| | temperature | 3 h | 3 h | 3 h | 3 h | 3 h | 3 h | 3 h |
| | crystal phase | LS2 | LS2 | LS2 | Cri. | LS2 | Cri | Cri. LS2 |
| | | Cri. | Cri. | Cri. | LS2 LS | Cri. | LS2 LS | Quartz |

| | | | | | | | |
|---|---|---|---|---|---|---|---|
| λ80/nm(1 mmt) | 708 | 729.5 | 659.5 | Not | 601 | Not | |
| | | | | measurable | | measurable | |
| λ5/nm(1 mmt) | 301 | 350.5 | 294.5 | 466.5 | 272.5 | 380 | |
| Transmittance [%]@450 nm | 41 | 30 | 49 | 4 | 59 | 14 | |
| Hv_200 gf | 742 | 715 | 754 | 671 | 711 | 669 | 667 |

TABLE 2

| | | Example 8 | Example 9 | Example 10 | Example 11 | Example 12 | Example 13 | Example 14 |
|---|---|---|---|---|---|---|---|---|
| wt. % | SiO2 | 76.36 | 77.36 | 71.86 | 71.41 | 71.06 | 76.36 | 72.80 |
| | Al2O3 | 3.24 | 3.24 | 3.51 | 4.00 | 4.31 | 3.24 | 3.55 |
| | B2O3 | | | | | | | |
| | P2O5 | 2.04 | 2.04 | 2.11 | 2.11 | 2.11 | 2.04 | 2.09 |
| | Li2O | 9.95 | 9.95 | 8.12 | 8.11 | 8.12 | 9.95 | 8.22 |
| | Na2O | | 0.50 | | | | | |
| | K2O | 0.73 | 0.73 | 3.15 | 3.14 | 3.15 | 0.73 | 3.19 |
| | MgO | | | 1.05 | 1.05 | 1.05 | | 0.56 |
| | CaO | | | 0.42 | 0.42 | 0.42 | | |
| | ZnO | 0.50 | 0.50 | 0.42 | 0.82 | 0.82 | 0.25 | 0.53 |
| | TiO2 | | | | | | | |
| | ZrO2 | 7.10 | 5.60 | 9.26 | 8.84 | 8.86 | 7.35 | 8.97 |
| | Nb2O5 | | | | | | | |
| | Gd2O3 | | | | | | | |
| | Sb2O3 | 0.08 | 0.08 | 0.09 | 0.09 | 0.09 | 0.08 | 0.09 |
| | total | 100.00 | 100.00 | 100.00 | 100.00 | 100.00 | 100.00 | 100.00 |
| | (Si + Li)/Al | 26.64 | 26.95 | 22.80 | 19.88 | 18.38 | 26.64 | 22.81 |
| | (K + Al)/Zr | 0.56 | 0.71 | 0.72 | 0.81 | 0.84 | 0.54 | 0.75 |
| | (P + K + Mg + Al)/Zr | 0.85 | 1.07 | 1.06 | 1.16 | 1.20 | 0.82 | 1.05 |
| Crystallization | Nucleation | 540 °C × | 540 °C × | 540 °C × | 540 °C × | 540 °C × | 540 °C × | 540 °C × |
| condition | temperature | 5 h | 5 h | 5 h | 5 h | 5 h | 5 h | 5 h |
| | Crystallization | 730 °C × | 730 °C × | 730 °C × | 720 °C × | 730 °C × | 730 °C × | 740 °C × |
| | temperature | 3 h | 3 h | 3 h | 3 h | 3 h | 3 h | 3 h |
| | crystal phase | LS2 | LS2 | LS2 | LS2 | LS2 | LS2 | LS2 |
| | | Cri. | Cri. | Cri. | Cri. | Cri. | Cri. | Cri. LS |

| | | | | | | | |
|---|---|---|---|---|---|---|---|
| λ80/nm(1 mmt) | 537 | 566.5 | Not | Not | Not | 551.5 | Not |
| | | | measurable | measurable | measurable | | measurable |
| λ5/nm(1 mmt) | 256 | 265.5 | 535 | 471.5 | 596.5 | 262 | 384 |
| Transmittance [%]@450 nm | 70 | 65 | 2 | 4 | 2 | 68 | 12 |
| Hv_200 gf | 727 | 737 | 665 | 651 | 671 | 713 | 669 |

TABLE 3

| | | Example 15 | Example 16 | Example 17 | Example 18 | Example 19 | Example 20 | Example 21 |
|---|---|---|---|---|---|---|---|---|
| wt. % | SiO2 | 71.91 | 75.84 | 74.86 | 75.78 | 76.36 | 76.36 | 70.86 |
| | Al2O3 | 3.51 | 3.18 | 3.18 | 3.74 | 5.24 | 3.24 | 2.74 |
| | B2O3 | | 1.96 | 1.96 | | | | 2.00 |
| | P2O5 | 2.36 | 2.00 | 2.00 | 2.14 | 2.04 | 2.04 | 2.54 |
| | Li2O | 8.12 | 9.75 | 9.75 | 9.94 | 7.95 | 9.95 | 9.95 |
| | Na2O | | 0.49 | | | | | 0.50 |
| | K2O | 3.15 | 0.72 | 0.72 | 0.73 | 0.73 | 0.73 | 0.73 |
| | MgO | 1.05 | | | | | | |
| | CaO | 0.42 | | | | | | |
| | ZnO | 0.52 | 0.49 | 0.25 | 0.50 | 0.50 | 0.50 | 0.50 |
| | TiO2 | | | | | | 2.00 | |
| | ZrO2 | 8.86 | 5.49 | 7.21 | 7.09 | 7.10 | 5.10 | 10.10 |
| | Nb2O5 | | | | | | | |
| | Gd2O3 | | | | | | | |
| | Sb2O3 | 0.09 | 0.08 | 0.08 | 0.08 | 0.08 | 0.08 | 0.08 |
| | total | 100.00 | 100.00 | 100.00 | 100.00 | 100.00 | 100.00 | 100.00 |
| | (Si + Li)/Al | 22.81 | 26.95 | 26.64 | 22.94 | 16.09 | 26.64 | 29.49 |
| | (K + Al)/Zr | 0.75 | 0.71 | 0.54 | 0.63 | 0.84 | 0.78 | 0.34 |
| | (P + K + Mg + Al)/Zr | 1.14 | 1.07 | 0.82 | 0.93 | 1.13 | 1.18 | 0.60 |
| Crystallization | Nucleation | 540 °C × | 540 °C × | 540 °C × | 540 °C × | 540 °C × | 540 °C × | 540 °C × |
| condition | temperature | 5 h | 5 h | 5 h | 5 h | 5 h | 5 h | 5 h |
| | Crystallization | 730 °C × | 700 °C × | 700 °C × | 720 °C × | 700 °C × | 710 °C × | 700 °C × |
| | temperature | 3 h | 3 h | 3 h | 3 h | 3 h | 3 h | 3 h |
| | crystal phase | Cri. | LS2 | LS2 Cri. | LS2 | Cri. LS2 | LS2 | LS2 Cri. |
| | | LS2 | Cri. | Quartz | Cri. | LS Petalite | Cri. | LS |

| | | | | | | | |
|---|---|---|---|---|---|---|---|
| λ80/nm(1 mmt) | | 746.5 | 615 | 551 | Not | 647 | 742.5 |
| | | | | | measurable | | |
| λ5/nm(1 mmt) | | 338 | 293.5 | 274.5 | 391 | 337.5 | 315 |
| Transmittance [%]@450 nm | | 32 | 56 | 67 | 13 | 45 | 36 |
| Hv_200 gf | 655 | 727 | 725 | 717 | 632 | 729 | 691 |

TABLE 4

| | | Example 22 | Example 23 | Example 24 | Example 25 | Example 26 | Example 27 | Comp. Ex. 1 |
|---|---|---|---|---|---|---|---|---|
| wt. % | SiO2 | 74.79 | 75.78 | 75.78 | 75.78 | 75.78 | 76.36 | 64.86 |
| | Al2O3 | 3.74 | 3.74 | 3.74 | 3.74 | 3.74 | 3.74 | 12.44 |
| | B2O3 | | | | | | | 3.00 |
| | P2O5 | 2.14 | 2.14 | 2.14 | 2.14 | 2.14 | 2.04 | 2.04 |
| | Li2O | 9.94 | 9.94 | 9.94 | 9.94 | 9.94 | 9.45 | 7.14 |
| | Na2O | | | | | 0.30 | | |
| | K2O | 0.73 | 0.43 | 0.43 | 0.43 | 0.43 | 0.73 | 1.53 |
| | MgO | | 0.30 | | | | | 1.02 |
| | CaO | | | | | | | 0.41 |
| | ZnO | 0.50 | 0.50 | 0.50 | 0.50 | 0.50 | 0.50 | 1.88 |
| | TiO2 | | | | | | | |
| | ZrO2 | 8.09 | 7.09 | 7.39 | 7.09 | 7.09 | 7.12 | 5.60 |
| | Nb2O5 | | | | 0.30 | | | |
| | Gd2O3 | | | | | | | |
| | Sb2O3 | 0.08 | 0.08 | 0.08 | 0.08 | 0.08 | 0.06 | 0.08 |
| | total | 100.00 | 100.00 | 100.00 | 100.00 | 100.00 | 100.00 | 100.00 |
| | (Si + Li)/Al | 22.68 | 22.94 | 22.94 | 22.94 | 22.94 | 22.94 | 5.79 |
| | (K + Al)/Zr | 0.55 | 0.59 | 0.56 | 0.59 | 0.59 | 0.63 | 2.49 |
| | (P + K + Mg + Al)/Zr | 0.82 | 0.93 | 0.85 | 0.89 | 0.89 | 0.91 | 3.04 |
| Crystallization | Nucleation | 540 °C × | 540 °C × | 540 °C × | 540 °C × | 540 °C × | 540 °C × | 600 °C × |
| condition | temperature | 5 h | 5 h | 5 h | 5 h | 5 h | 5 h | 5 h |
| | Crystallization | 720 °C × | 730 °C × | 730 °C × | 730 °C × | 720 °C × | 720 °C × | 660 °C × |
| | temperature | 3 h | 3 h | 3 h | 3 h | 3 h | 3 h | 5 h |
| | crystal phase | LS2 | LS2 | LS2 Cri. | LS2 Cri. | LS2 | LS2 | Cri. |
| | | Cri. LS | Cri. | Petalite | Quartz | Cri. | Cri. | |

| | | | | | | | |
|---|---|---|---|---|---|---|---|
| λ80/nm(1 mmt) | 536.5 | 614 | 574.5 | 596.5 | 539.5 | 600.5 | 430.5 |
| λ5/nm(1 mmt) | 264 | 310.5 | 296.5 | 304 | 268.5 | 277 | 252.5 |
| Transmittance [%]@450 nm | 70 | 52 | 60 | 56 | 69 | 59 | 82 |
| Hv_200 gf | 717 | 735 | 727 | 725 | 737 | 721 | 613 |

TABLE 5

| | | Example | Example | Example | Comp. |
|---|---|---|---|---|---|
| | | 8 | 24 | 27 | Ex. 2 |
| Substrate | | 1.03 | 1.04 | 0.68 | 0.60 |
| Thickness (mm) | | | | | |
| Strengthening | First | NaNO₃ | NaNO₃ | NaNO₃ | NaNO₃ |
| conditions | stage | 470 °C × | 470 °C × | 470 °C × | 470 °C × |
| | | 240 min. | 240 min. | 300 min. | 300 min. |
| | Second | KNO₃ | KNO₃ | KNO₃ | KNO₃ |
| | stage | 430 °C × | 430 °C × | 430 °C × | 430 °C × |
| | | 500 min. | 500 min. | 500 min. | 500 min. |

| | | | | |
|---|---|---|---|---|
| CS (MPa) | 562 | 524 | 604 | 372 |
| CT (MPa) | 42 | 46 | 76 | 16 |
| DOLzero (μm) | 163 | 153 | 136 | 112 |

Although only some exemplary embodiments and/or examples of this invention have been described in detail above, those skilled in the art will readily appreciate that many modifications are possible in the exemplary embodiments and/or examples without materially departing from the novel teachings and advantages of this invention. Accordingly, all such modifications are intended to be included within the scope of this invention.

The documents described in the specification and the specification of Japanese application(s) on the basis of which the present application claims Paris convention priority are incorporated herein by reference in its entirety.

1. Crystallized glass comprising α-cristobalite and disilicate lithium as main crystal phases, wherein
the crystallized glass has, by mass % in terms of oxide,
a content of a SiO₂ component of 65.0% to 85.0%,
a content of an Al₂O₃ component of 1.5% to 5.9%,
a content of a P₂O₅ component of more than 0% and 5.0% or less,
a content of a Li₂O component of 5.0% to 10.8%, and
a content of a ZrO₂ component of 4.0% to 12.5%, and wherein
[(the content of the SiO₂ component+the content of the Li₂O component)/the content of the Al₂O₃ component] is more than 13.9.

2. The crystallized glass according to claim 1, wherein the crystallized glass has, by mass % in terms of oxide,
a content of a B₂O₃ component of 0% to 5.0%,
a content of a Na₂O component of 0% to 5.0%,
a content of a K₂O component of 0% to 5.0%,
a content of a MgO component of 0% to 5.0%,
a content of a CaO component of 0% to 5.0%,
a content of a ZnO component of 0% to 5.0%,
a content of a TiO₂ component of 0% to 5.0%,
a content of a Gd₂O₃ component of 0% to 5.0%,
a content of a Sb₂O₃ component of 0% to 3.0%, and
a content of a Nb₂O₅ component of 0% to 3.0%.

3. The crystallized glass according to claim 1, wherein
the content of the ZrO₂ component is 4.7% to 12.5%.

4. The crystallized glass according to claim 1, wherein
the content of the ZrO₂ component is more than 7% and 12.5% or less.

5. The crystallized glass according to claim 1, wherein by mass % in terms of oxide,
[(a content of a K₂O component+a content of a Al₂O₃ component)/a content of a ZrO₂ component] is less than 0.88.

6. The crystallized glass according to claim 1, wherein by mass % in terms of oxide,
[(a content of a P₂O₅ component+a content of a K₂O component+a content of a MgO component+a content of a Al₂O₃ component)/a content of a ZrO₂ component] is less than 1.32.

7. The crystallized glass according to claim 1, having a compressive stress layer on the surface thereof.

8. The crystallized glass according to claim 1, which is used for a glass member of a smartphone.
